(19) United States
(12) Patent Application Publication
(10) Pub. No.: US 2002/0120930 A1
(43) Pub. Date: Aug. 29, 2002

(54) Systems and methods for encouraging advertising consumption

(75) Inventor: Boaz Yona, Jerusalem (IL)

Correspondence Address: DR. Mark Friedman LTD, c/o Bill Polkinghorn- Discovery Dispatch, 9003 Florin Way, Upper Marlboro, MD, 20772, US

(73) Assignee: E.M.T.V. EFFECTIVE MEDIA LTD.

(21) Appl. No.: 09/908,839

(22) Filed: Jul. 20, 2001

Related U.S. Application Data
(60) Provisional application No. 60/270,896, filed on Feb. 26, 2001.

(51) Int. Cl. H04N 7/16; H04H 9/00; G06F 17/60; H04N 7/025; H04N 7/10

(52) U.S. Cl. 725/34; 725/9; 725/23; 725/35; 725/136

(57) ABSTRACT

Systems and methods rewarding consumption of broadcast advertising as a means of encouraging further consumption of broadcast advertising. Further disclosed are systems and methods for measuring the effect of rewarding broadcast audience members for consumption of advertising. The system includes a broadcast infrastructure, a mechanism for verifying actual consumption of advertising by an individual audience member and a mechanism for rewarding the audience member in return for the actual consumption. The method includes the steps of broadcasting advertising to an audience verifying actual consumption of the advertising by an individual and rewarding the individual in return for the actual consumption. Measurement of effect is achieved by correlating an individual's advertising consumption to subsequent purchase behavior.

This application is derives priority from U.S. provisional application 60/270,896 filed on Feb. 26, 2001.

### FIELD AND BACKGROUND OF THE INVENTION

The present invention relates to systems and methods for encouraging advertising consumption and, more particularly, to a system and method for monitoring the consumption of broadcast advertising content and rewarding consumption thereof as a means of encouraging further consumption of broadcast advertising content. The present invention further relates to systems and methods for measuring the effect of rewarding broadcast audience members for consumption of advertising content.

In capitalist economies, program content on television and radio is typically accompanied by advertising provided by sponsors. In this way, content providers enjoy a stream of revenue from the advertisers. It has long been known that certain programming enjoys a wider audience than other programming. Reasons for this include, but are not limited to, time of broadcast and content.

Traditionally, prices charged to advertisers were based upon the measured popularity of the programming into which the advertising was inserted. However, a phenomenon known as “drop-off” has recently been described. Drop-off refers to the tendency of consumers to cease broadcast reception at the perceived beginning of an advertisement. Cessation may take several forms such as leaving the room, changing channels, engaging in another activity during advertising or shutting off a broadcast-receiving device.

PCT application WO 00/62184 teaches an electronic incentive program to encourage advertising consumption. However, the teachings of this patent are not suited to use with broadcast adverting content. Further, teachings of this patent do not provide a means for correlating off-line purchasing behavior of a specific consumer with exposure to advertising content of the same consumer.

U.S. Pat. No. 6,061,660 teaches an Internet award system but does not teach rewarding a consumer in proportion to the amount of advertising content consumed. However, the teachings of this patent are not suited to use with broadcast adverting content. Further, teachings of this patent do not provide a means for correlating off-line purchasing behavior of a specific consumer with exposure to advertising content of the same consumer.

U.S. Pat. No. 5,791,991 teaches a consumer product promotion match game. Although the game is played via an interactive electronic terminal, use of the game to stimulate consumption of advertising content during a broadcast is not taught. Further, teachings of this patent do not provide a means for correlating off-line purchasing behavior of a specific consumer with exposure to advertising content of the same consumer.

PCT application WO 00/68756 teaches an advertising incentive program for use on the Internet. However, the teachings of this patent are not suited to use with broadcast adverting content. Further, teachings of this patent do not provide a means for correlating off-line purchasing behavior of a specific consumer with exposure to advertising content of the same consumer.

U.S. Pat. No. 5,768,521 teaches a general purpose metering mechanism for electronic information including a system for crediting a user account when an advertisement is viewed. However, the teachings of this patent are not suited to use with broadcast adverting content. Further, teachings of this patent do not provide a means for correlating off-line purchasing behavior of a specific consumer with exposure to advertising content of the same consumer.

PCT application WO 0101308 teaches virtual television program rating but does not teach a reward system to encourage consumption of advertising content. The system requires the Internet, although assessment of broadcast content is achieved. Further, teachings of this patent do not provide a means for correlating off-line purchasing behavior of a specific consumer with exposure to advertising content of the same consumer.

There is thus a widely recognized need for, and it would be highly advantageous to have, systems and methods for encouraging advertising consumption which would reduce drop-off. Further, there is a widely recognized need for, and it would be highly advantageous to have, systems and methods for measuring the effect of rewarding broadcast audience members for consumption of advertising content.

### SUMMARY OF THE INVENTION

According to one aspect of the present invention there is provided a system for encouraging consumption of advertising content by individual broadcast audience members belonging to a plurality of broadcast audience members by rewarding the individual broadcast audience member that consumes advertising content. The system includes: (a) a first data collection mechanism designed and configured to ascertain a time at which, and a channel on which, content is consumed by an individual broadcast audience member belonging to the plurality of broadcast audience members; (b) a second data collection mechanism designed and configured to determine a time at which, and a channel on which, the advertising content is broadcast; (c) a comparison mechanism, the comparison mechanism designed and configured to determine actual consumption of the advertising content by the individual broadcast audience member belonging to the plurality of broadcast audience members; and (d) a reward mechanism designed and configured to credit an account of the individual broadcast audience member belonging to the plurality of broadcast audience members with a reward. The first data collection mechanism and the second data collection mechanism are each capable of communicating collected data to the comparison mechanism and the comparison mechanism is capable of communicating data concerning the actual consumption to the reward mechanism.

According to another aspect of the present invention there is provided a system for encouraging consumption of advertising content by individual broadcast audience members belonging to a plurality of broadcast audience members by rewarding the individual broadcast audience members that consume advertising content. The system includes: (a) a broadcast infrastructure broadcasting the advertising content to the plurality of broadcast audience members; (b) a mechanism for verifying actual consumption of the advertising content by an individual broadcast audience member belonging to the plurality of broadcast audience members; and (c) a mechanism for rewarding the individual broadcast audience member belonging to the plurality of broadcast audience members in return for the actual consumption.

According to yet another aspect of the present invention there is provided a method for encouraging consumption of advertising content by individual broadcast audience members belonging to a plurality of broadcast audience members by rewarding the individual broadcast audience members that consume advertising content. The method comprises the steps of: (a) broadcasting the advertising content to the plurality of broadcast audience members; (b) verifying actual consumption of the advertising content by an individual broadcast audience member belonging to the plurality of broadcast audience members; and (c) rewarding the individual broadcast audience member belonging to the plurality of broadcast audience members in return for the actual consumption.

According to still another aspect of the present invention there is provided a system for measuring the effect of rewarding individual broadcast audience members belonging to a plurality of broadcast audience members for consumption of advertising content. The system includes: (a) a broadcast infrastructure broadcasting the advertising content to the plurality of broadcast audience members; (b) a mechanism for verifying actual consumption of the advertising content by an individual broadcast audience members belonging to the plurality of broadcast audience members; (c) a mechanism for rewarding the individual broadcast audience member belonging to the plurality of broadcast audience members in return for the actual consumption; (d) a database containing information from the mechanism for rewarding correlated to information concerning purchases made by the individual broadcast audience member.

According to an additional aspect of the present invention there is provided a method for measuring the effect of rewarding individual broadcast audience members belonging to a plurality of broadcast audience members for consumption of advertising content, the method includes the steps of: (a) broadcasting advertising content to the plurality of broadcast audience members; (b) verifying actual consumption of the advertising content by an individual broadcast audience member belonging to the plurality of broadcast audience members; and (d) rewarding the individual broadcast audience member belonging to the plurality of broadcast audience members in return for the actual consumption; and (e) correlating information concerning the step of rewarding to information concerning purchases made by the individual broadcast audience member.

According to further features in preferred embodiments of the invention described below, the actual consumption is deemed to occur only if the individual broadcast audience member inputs additional data to the first data collection mechanism, the additional data verifying the actual consumption.

According to still further features in the described preferred embodiments the advertising content is delivered in sequence with programming content.

According to still further features in the described preferred embodiments the advertising content is embedded within programming content.

According to still further features in the described preferred embodiments the broadcast occurs in a medium selected from the group consisting of television and radio.

According to still further features in the described preferred embodiments the broadcast is selected from the group consisting of a conventional broadcast, a cable broadcast, a satellite broadcast, a wireless broadcast and combinations thereof.

According to still further features in the described preferred embodiments the reward is selected from the group consisting of at least one point, at least one credit, a discount, a tangible prize, a monetary award, a chance to participate in a quiz and a chance to participate in a lottery.

According to still further features in the described preferred embodiments the system further includes a reward redemption mechanism.

According to still further features in the described preferred embodiments the reward redemption mechanism employs at least one item selected from the group consisting of a prize redemption channel, the Internet, a telephone connection, a fax connection, a credit card, a designated membership card and a merchant.

According to still further features in the described preferred embodiments the account is selected from the group consisting of a designated rewards account, a credit card account, a bank account, an account with a merchant, an account with a consortium of merchants and a broadcast service provider account.

According to still further features in the described preferred embodiments wherein the additional data includes answers to questions concerning the advertising content broadcast.

According to still further features in the described preferred embodiments the mechanism for rewarding employs an account selected from the group consisting of a designated rewards account, a credit card account, a bank account, an account with a merchant, an account with a consortium of merchants and a broadcast service provider account.

According to still further features in the described preferred embodiments the step of verifying includes requiring input of additional data by the individual broadcast audience member, the additional data verifying the actual consumption.

According to still further features in the described preferred embodiments the step of broadcasting the advertising content occurs sequentially with broadcasting of programming content.

According to still further features in the described preferred embodiments the step of broadcasting the advertising content includes embedding the advertising content within programming content.

According to still further features in the described preferred embodiments the step of rewarding includes issuing a reward selected from the group consisting of at least one point, at least one credit, a discount, a tangible prize, a monetary award, a chance to participate in a quiz and a chance to participate in a lottery.

According to still further features in the described preferred embodiments the method further includes the step of (e) facilitating redemption of a reward issued during the step of rewarding.

According to still further features in the described preferred embodiments the step of facilitating redemption employs at least one item selected from the group consisting of a prize redemption channel, the Internet, a telephone connection, a fax connection, a credit card, a designated membership card and a merchant.

According to still further features in the described preferred embodiments the database correlates information from the mechanism for rewarding to information concerning purchases made by the individual broadcast audience member by means of a purchasing account.

According to still further features in the described preferred embodiments the purchasing account is selected from the group consisting of a credit card account, a debit card account, a consumer club account and, a merchant based account and combinations thereof.

According to still further features in the described preferred embodiments the database correlates information from the mechanism for rewarding to information concerning purchases made by the individual broadcast audience member by means of a purchasing account.

According to still further features in the described preferred embodiments the purchasing account is selected from the group consisting of a credit card account, a debit card account, a consumer club account and, a merchant based account and combinations thereof.

The present invention successfully addresses the shortcomings of the presently known configurations by providing systems and methods for encouraging advertising consumption by monitoring the consumption of broadcast advertising content and rewarding consumption thereof as a means of encouraging further consumption of broadcast advertising content. The present invention further permits measurement of the effectiveness of rewarding broadcast audience members for consumption of advertising content using those systems and methods.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic diagram illustrating the arrangement of components in a system according to the present invention;

FIG. 2 is a flow diagram of steps in a method according to the present invention;

FIGS. 3 and 4 depict one embodiment of a user interface for entry of additional data according to the present invention;

FIGS. 5, 6 and 7 depict one embodiment of a user interface for a lottery according to the present invention; and

FIG. 8 depicts a reward interface for use in conjunction with the lottery interface of FIGS. 5-7.

### DESCRIPTION OF THE PREFERRED EMBODIMENTS

The present invention is of systems and methods for encouraging advertising consumption which can be employed for monitoring the consumption of broadcast advertising content and rewarding consumption thereof as a means of encouraging further consumption of broadcast advertising content Specifically, the present invention can be used to prevent viewer drop-off as defined hereinabove.

The present invention is further of systems and methods for measuring the effect of rewarding broadcast audience members for consumption of advertising content.

The principles and operation of systems and methods according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology lo employed herein is for the purpose of description and should not be regarded as limiting.

For purposes of this specification and the accompanying claims, the phrase “channel of communication” refers to a telephone connection, a cellular telephone connection, an Internet connection, an infrared frequency transmission connection, a local area network connection, a radio frequency connection, a satellite link, a fiber-optic connection or a connection by a wire. Inherent in the idea of a communication channel is an open status during which data transmission may occur. In some cases, communication channels may also have a closed status during which no data transmission may occur. Communication via the infrastructure of a television service provider is specifically included in this definition.

For purposes of this specification and the accompanying claims, the phrase “communication device” refers to a telephone, a cellular telephone, a modem, an infrared frequency transmission device, a set top box, a server, a radio transceiver and a television. Specifically included in this definition is a remote control unit for a television receiver.

For purposes of the specification and the accompanying claims the phrase “display device” refers to any device for presentation of data to a user. The definition includes, but is not limited to speakers, earphones, LCD screens, LED displays, CRT displays and active matrix displays and combinations thereof. The most common display device in the context of the present invention is a broadcast monitor, i.e. a television, Web TV or radio receiver.

For purposes of this specification and the accompanying claims the phrase “input device” refers to any device for entry of data. The definition includes, but is not limited to a keyboard, a computer mouse, a track pad, a track ball, a stylus, a touch screen, a joystick and a microphone. Specifically included in this definition is a remote control unit for a television receiver.

For purposes of this specification and the accompanying claims the phrase “user profile” refers to any compilation of data regarding the age, gender, socioeconomic status, educational level, personal status, habits or tastes of a user, data pertaining to previous actions performed by the user in response to content displayed according to the present invention, a location of the user, and account data.

For purposes of this specification and the accompanying claims the terms “sponsor”, “sponsored” and “sponsorship” refer to display of advertising content promoting a product of a first party in entertainment content consumed by a second party.

For purposes of this specification and the accompanying claims, the term “server” refers to any computing machine capable of exchanging data with at least one other computing machine. A single server may comprise an individual computing machine or a plurality of such machines acting in concert to perform a function requested by at least one other computing machine.

For purposes of this specification and the accompanying claims the phrase “drop-off” refers to the tendency of a broadcast audience member to cease broadcast reception at the perceived beginning of an advertisement. Cessation of reception may take many forms, including but not limited to, leaving the room, changing channels, operating a muting device or shutting off a broadcast receiving device. Alternately, or additionally, drop-off may occur if a broadcast audience member engages in another activity when advertising is perceived to appear, for example conversing with a companion, knitting, or reading a book.

For purposes of this specification and the accompanying claims the term “broadcast” refers to synchronous transmission of content to a plurality of broadcast audience members at a specified time.

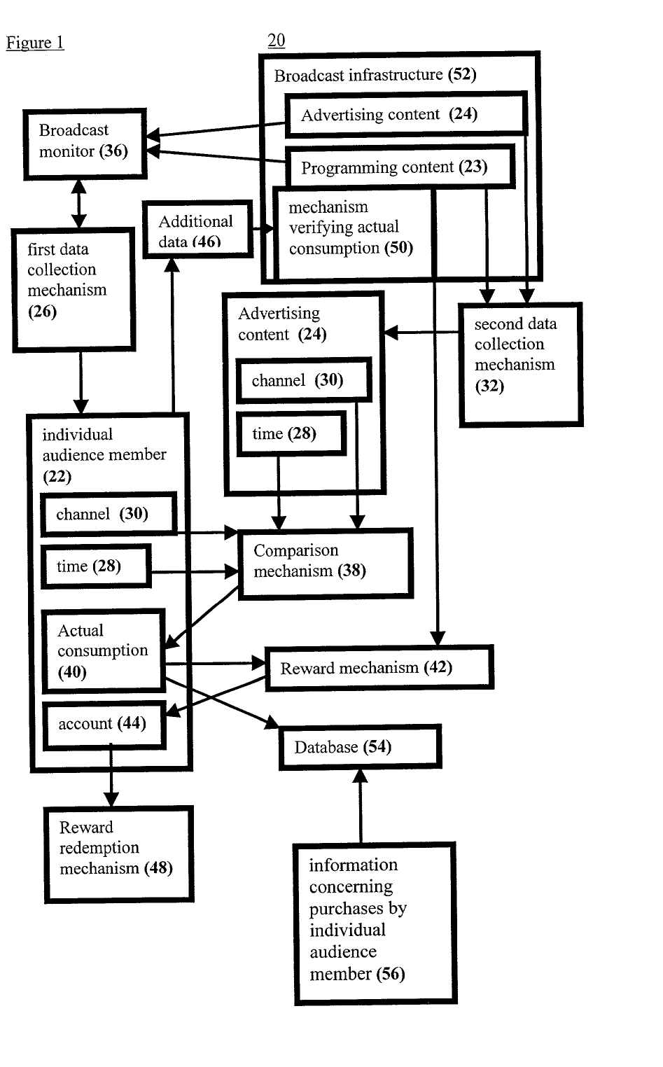

Referring now to the drawings, FIG. 1 illustrates a system 20 for encouraging consumption of advertising content by individual broadcast audience members 22 by rewarding individual broadcast audience member 22 that consumes advertising content 24. Individual broadcast audience members 22 belong to a plurality of broadcast audience members although only one audience member 22 is pictured.

System 20 includes a first data collection mechanism 26 designed and configured to ascertain a time 28 at which, and a channel 30 on which, content (23 and 24) is consumed by individual broadcast audience member 22 belonging to the plurality of broadcast audience members. In embodiments of system 20 in which a digital set top box is employed, determination of time 28 and channel 30 combinations may be determined locally. According to alternate embodiments of system 20, click-stream data from a remote control input device is transmitted to comparison mechanism 38 which includes a server capable of transforming the click-stream-data to time 28 and channel 30 combinations. This transmission may be via any channel of communication, although telephone and cable (from cable TV lines) are the most common channels of communication employed. Both advertising content 24 and programming content 30 are received on broadcast monitor 36 which functions as a display device for broadcast audience member 22. Collection of click-stream data is well known in the art of broadcast service provision and one ordinarily skilled in that art will be capable of adapting existing technologies for use in conjunction with the present invention.

Broadcast audience member 22 may be either an individual, or several individuals residing together. According to various embodiments of the invention, a group of people residing together may be rewarded for consuming advertising content 24 either individually or as a group. First data collection mechanism 26 may reside in broadcast monitor 36 or in a set top box attached thereto or in a remote control unit associated with broadcast monitor 36.

System 20 further includes a second data collection mechanism 32 designed and configured to determine a time 28 at which, and a channel 30 on which, advertising content 24 is broadcast. Second mechanism 32 may rely, for example, on Idioma™ technology. Idioma™ uses a video camera and computer to determine when 28 advertising content 24 is actually broadcast on a specific channel 30. This technology is further capable of identifying specific advertising content 24. Idioma™ technology is well known in the art of broadcast marketing and one ordinarily skilled in that art will be capable of adapting Idioma™ technology for use in conjunction with the present invention.

System 20 further includes a comparison mechanism 38 designed and configured to determine actual consumption 40 of the advertising content by the audience member 22 belonging to the plurality of broadcast audience members. This is accomplished by comparing time 28 and channel 30 information for advertising content 24 to time 28 and channel 30 information for audience member 22. Only one audience member 22 is shown for simplicity, although simultaneous monitoring of many audience members 22 is an object of the invention.

System 20 further includes a reward mechanism 42 designed and configured to credit an account 44 of the audience member 22 belonging to the plurality of broadcast audience members with a reward. The reward may be, for example, at least one point, at least one credit, a discount, a tangible prize, a monetary award, a chance to participate in a quiz or a chance to participate in a lottery. Account 44 may be, for example, a designated rewards account, a credit card account, a bank account, an account with a merchant, an account with a consortium of merchants and a broadcast service provider account.

According to one embodiment of system 20, first data collection mechanism 26 and second data collection mechanism 32 are each capable of communicating collected data to comparison mechanism 38 and comparison mechanism 38 is capable of communicating data concerning actual consumption 40 to the reward mechanism 42.

System 20 can monitor consumption of advertising content 24 according to either a passive model or an active model. The description herein above relates to a passive model. In such a model, actual consumption is deemed to occur if broadcast monitor 36 is on a channel 30 at a time 28 when advertising content 24 is broadcast. This passive model of rewards does not prevent all types of drop-off as defined hereinabove.

System 20 can also monitor actual consumption according to an active model. This requires monitoring of active consumption. In such a case, actual consumption 40 is deemed to occur only if audience member 22 inputs additional data 46 to first data collection mechanism 26 to verify actual consumption 40 of advertising content 24. Additional data 46 may be, for example, a series of numbers briefly displayed during advertisements 24 broadcast during a single block of programming content 23. Alternately, data 46 may be, for example, answers to questions concerning advertising content 24.

Typically, advertising content 24 is delivered in sequence with programming content 23, for example as 15 or 30 second commercials. System 20 is capable of ascertaining time 28 with sufficient precision, for example 10-second increments, to accurately monitor consumption of advertising content 24.

Alternately, or additionally, advertising content 24 is embedded within programming content 23. For example, the protagonist in a drama 23 may drive a car produced by a sponsor. While this type of advertising has been known, system 20 increases the awareness of audience member 22 to the presence of advertising content 24 embedded in programming content 24.

Typically advertising content 24 is broadcast on either television or radio although other broadcast media are within the scope of the present invention, providing they meet the definition of broadcast provided hereinabove. A broadcast may be, for example a conventional broadcast, a cable broadcast, a satellite broadcast, a wireless broadcast and combinations thereof.

In some embodiments of system 20, a reward redemption mechanism 48 is further included. Redemption mechanism 48 may employ, for example, a prize redemption channel, the Internet, a telephone connection, a fax connection, a credit card, a designated membership card, a merchant or combinations thereof.

System 20 for encouraging consumption of advertising content by individual broadcast audience members 22 by consumption of advertising content 24 is further embodied by a broadcast infrastructure 54 broadcasting advertising content 24 to broadcast audience members 22 operating in concert with a mechanism 50 for verifying actual consumption advertising content 22 audience member 22 and a mechanism for rewarding 42 broadcast audience member 22 belonging to a plurality of broadcast audience members in return for actual consumption of advertising content 24. The mechanism for verifying 50 according to a passive rewards model might include first data collection mechanism 26, second data collection mechanism 32, and comparison mechanism 38. Alternately, or additionally, mechanism for verifying might include digital tags embedded in advertising content 24 received on broadcast monitor 36 and returned as additional data 46. The mechanism for verifying 50 according to an active rewards model might include additional data 46 in the form of answers to questions about advertising content 24, correct entry of characters of an alphanumeric string broadcast as part of advertising content 24, or timely response to a “respond now” command appearing as part of advertising content 24.

In some cases, the mechanism for rewarding will allow audience member 22 to directly claim a prize. In other cases, mechanism for rewarding 42 will employ an account, for example a designated rewards account, a credit card account, a bank account, an account with a merchant, an account with a consortium of merchants or a broadcast service provider account.

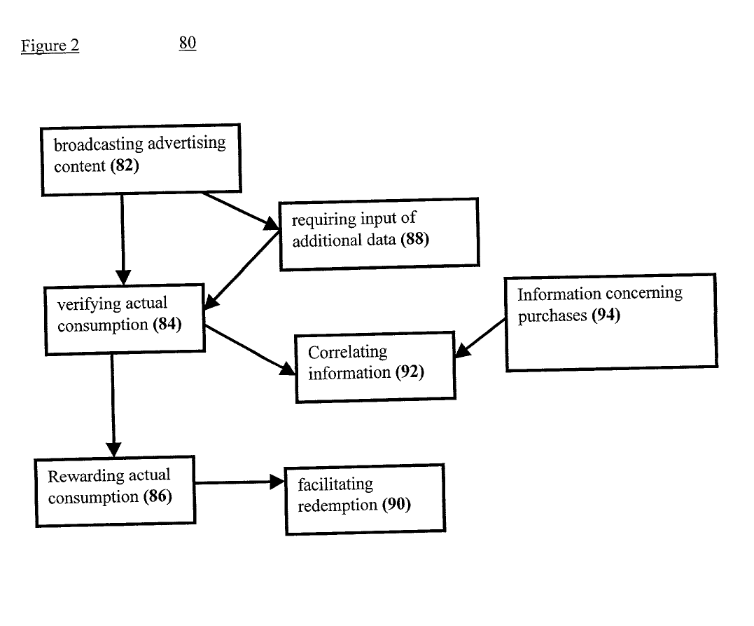

The present invention is further embodied by a method 80 (FIG. 2) for encouraging consumption of advertising content 24 by individual broadcast audience members 22 belonging to a plurality of broadcast audience members by rewarding the individual broadcast audience members that consume advertising content 24. Method 80 includes the steps of broadcasting 82 the advertising content to the plurality of broadcast audience members, verifying actual consumption 84 of the advertising content by an individual broadcast audience member 22 and rewarding 86 broadcast audience member 22 belonging to the plurality of broadcast audience members in return for the actual consumption 84.

According to some embodiments of system 80, step 84 of verifying includes requiring input 88 of additional data by broadcast audience member 22, wherein additional data 46 verifies actual consumption of advertising content 24. Input 88 is required for the active model of rewards, and may be used in some cases with a passive rewards model as described hereinabove. Broadcasting 82 of advertising content 24 may occur sequentially with broadcasting of programming content 23. Alternately, or additionally, broadcasting 82 of advertising content 24 includes embedding advertising content 24 within programming content.

The step of rewarding 86 may include issuing a reward such as, for example at least one point, at least one credit, a discount, a tangible prize, a monetary award, a chance to participate in a quiz and a chance to participate in a lottery.

Method 80 may further include facilitating redemption of a reward issued during step of rewarding 86. Facilitating redemption may employ, for example, a prize redemption channel, the Internet, a telephone connection, a fax connection, a credit card, a designated membership card or a merchant.

The present invention is further embodied by a system 20 for measuring the effect of rewarding individual broadcast audience members 22 for consumption of advertising content 24. In this case, system 20 includes broadcast infrastructure 52 broadcasting advertising content 24 to broadcast audience members 22, mechanism for verifying actual consumption 50 advertising content 24, mechanism for rewarding 42 and a database 54 containing information from the mechanism for rewarding correlated to information concerning purchases 56 made by broadcast audience members 22. Database 54 will typically contain a user profile for each audience member 22.

Database 54 correlates information from the mechanism for rewarding to information concerning purchases made by the individual broadcast audience member by means of a purchasing account. The purchasing account may be, for example a credit card account, a debit card account, a consumer club account a merchant based account or any combinations thereof.

The present invention is further embodied by a method 80 for measuring the effect of rewarding 86 broadcast audience members 22 for consumption of advertising content 24. Method 86 includes the steps of broadcasting 82 advertising content 24 to broadcast audience members 22, verifying 84 actual consumption of advertising content 24 by broadcast audience member 22, rewarding 86 the broadcast audience member 22 in return for the actual consumption and correlating information 92 concerning the step of rewarding 86 to information concerning purchases 94 made by audience member 22.

Correlation 92 of information from the mechanism 42 for rewarding to information concerning purchases 94 made by broadcast audience member 22 can be made by means of a purchasing account appearing in a user profile. The purchasing account may be, for example, a credit card account, a debit card account, a consumer club account and, a merchant based account and combinations thereof.

In order to demonstrate the workings of systems and methods according to the present invention, the following non-limiting illustrative example is provided. Axial Cable Company provides television service to 5 million viewers in a major metropolitan area. Axial viewers select from 164 channels. Axial is trying to introduce a new health and fitness channel (The H channel) featuring programming which they produce themselves. Because the channel is new, there are few viewers, drop-off is high and sponsorship revenues are low. Axial therefore implements systems 20 and methods 80 according to the present invention.

They begin by mailing free Axis cards to all Axial subscribers. An accompanying letter explains that the Axis card will serve three functions, first, the card number will serve as an account number for accumulation of reward points according to a passive rewards system. Second, the axis card will serve as an account for accumulation of bonus bucks for use in purchases at participating merchants. Finally, the same axis card will make the holder eligible for discounts at participating “H channel” sponsors.

The letter explains that reward points will be awarded as follows. 1 point for the first 15-second spot 24 viewed without changing channels, 5 points for the second consecutive spot 24 viewed without changing the channel and 25 points for viewing all the advertising spots 24 in a one-hour broadcast. Axial has set up their reward points program according to a progressive model in which viewers between 7:00 and 10:00 in the evening receive double points, although regressive models in which more points are earned late at night or during the day are within the scope of the present invention.

The letter further explains that at the end of each one-hour program, viewers will have a chance to key in numbers flashed on the screen during advertising spots 24. Successful entry of this additional data 46 will make viewers eligible to compete for bonus bucks, as well as valuable prizes.

Among recipients of the axis cards are the Foks family. The husband Jess Foks is not especially interested in the axis card, but his wife Poh and their daughter Lil are intrigued by the idea. That evening Jess wants to watch the “Sixers” game, but is over ruled by Poh and Lil who insist on tuning in to the “H” channel. At eight o'clock, as credits for “Fiber is your friend” begin to roll, scrolling letters at the bottom of the screen inform the Foks that this hour carries a potential 341 points in the new axis rewards program plus the possibility of winning additional prizes including a new SUV at the end of the hour by correctly entering numbers which appear during the advertisements.

During the first commercial spot for Vita-Juice sports beverage, the number 6 glows briefly in the lower right hand comer of the Foks TV screen. Lil jots it down on a piece of paper. Additional numbers appear during adds for nutrition supplements, home exercise equipment, a combination dietician/astrologer, a sport shoe manufacturer, a local car dealership, and an orthopedic mattress company.

According to some embodiments of system 20 and method 80, click-stream data from the Foks home is relayed to comparison mechanism 38 via their cable TV line. According to alternate embodiments of system 20 and method 80, a telephone connection is used for this purpose. According to the Axial Axis program, the Foks family counts as a single audience member 22. Alternately, each set top box provided by Axial could have slots for individual viewer keys, for example smart cards. This variation would transform the Foks family into three separate and distinct audience members 22.

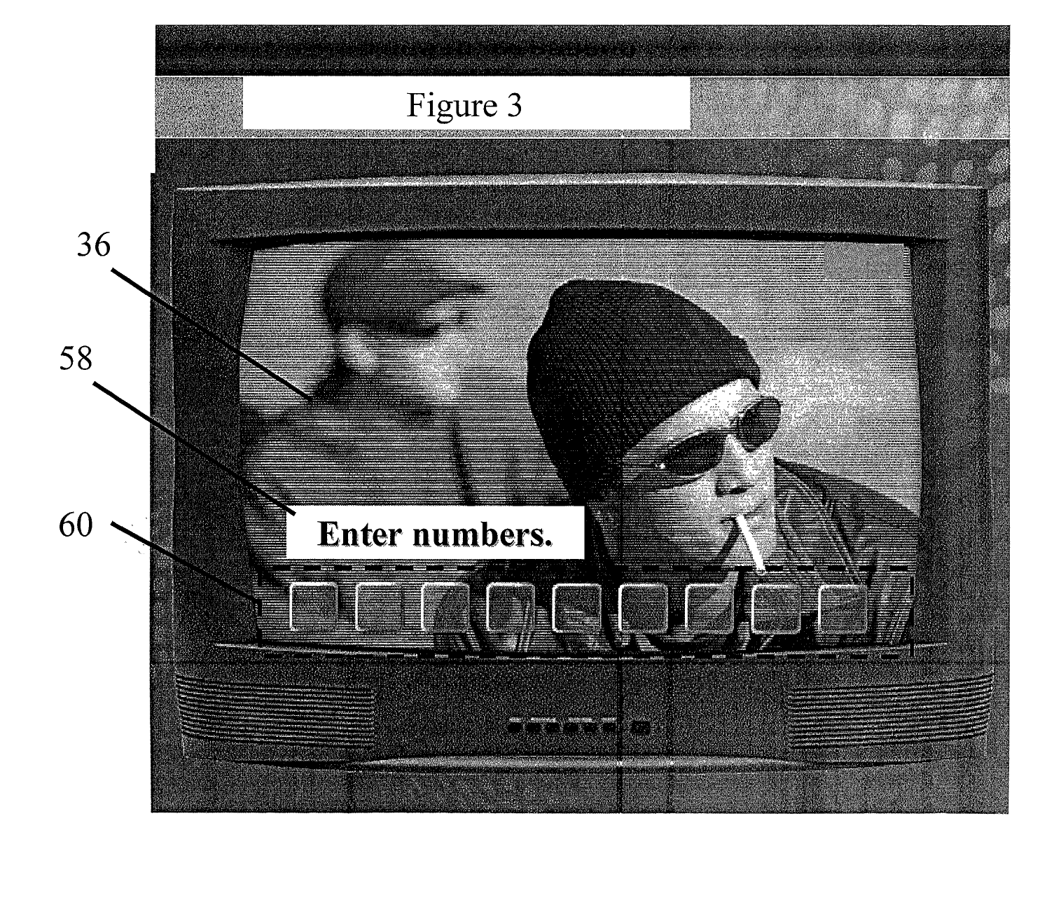

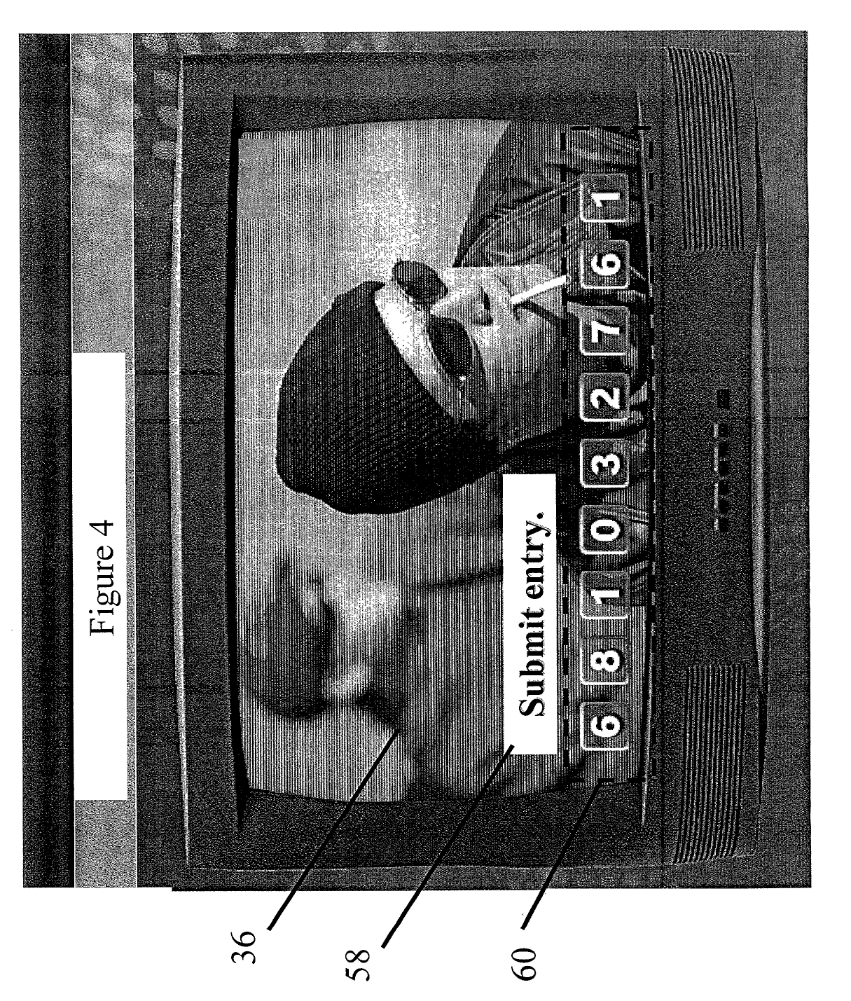

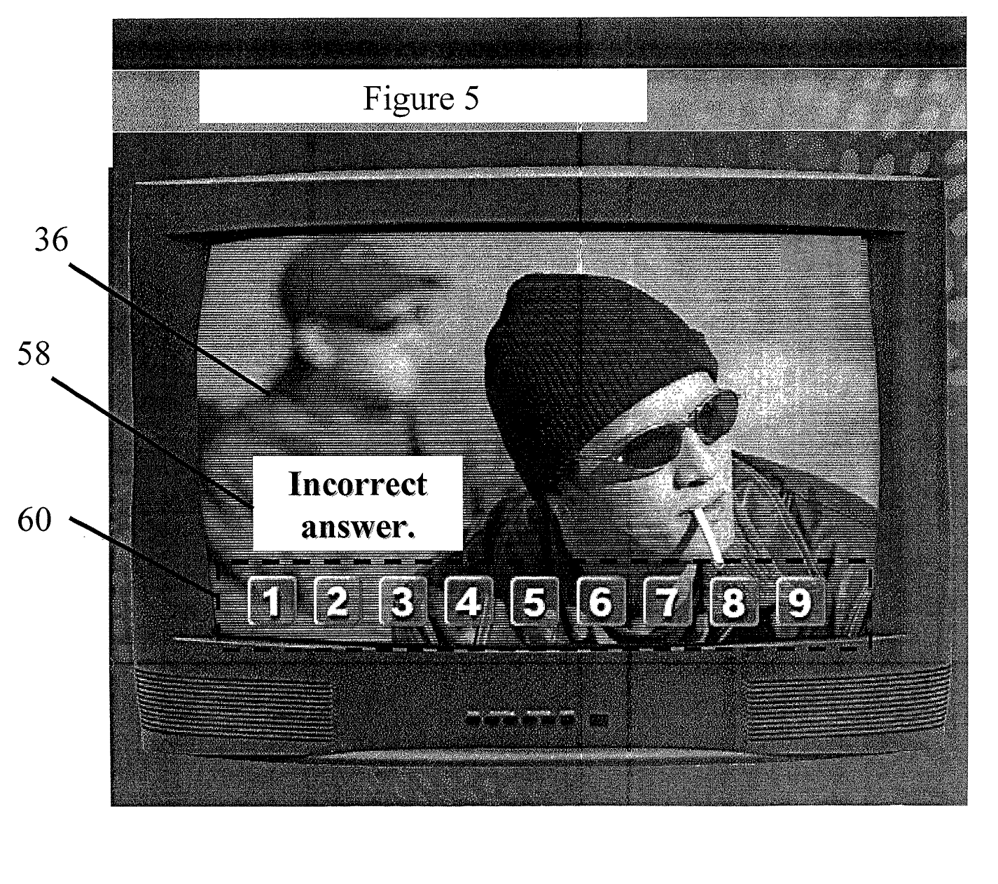

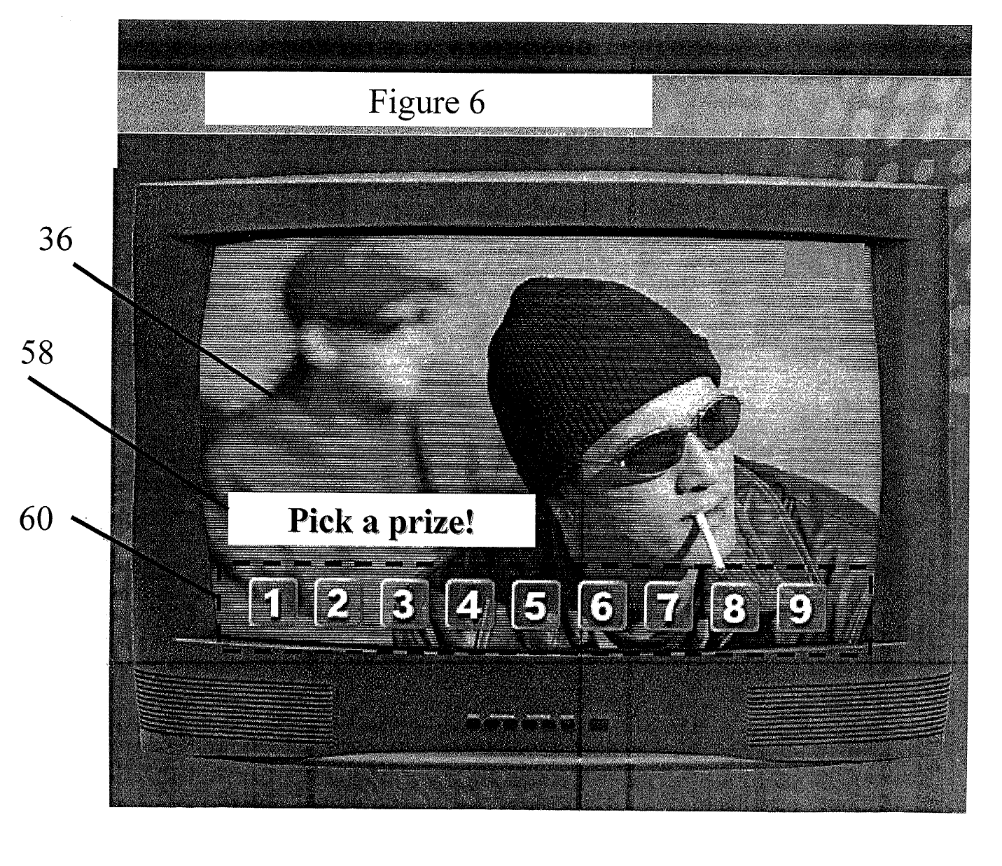

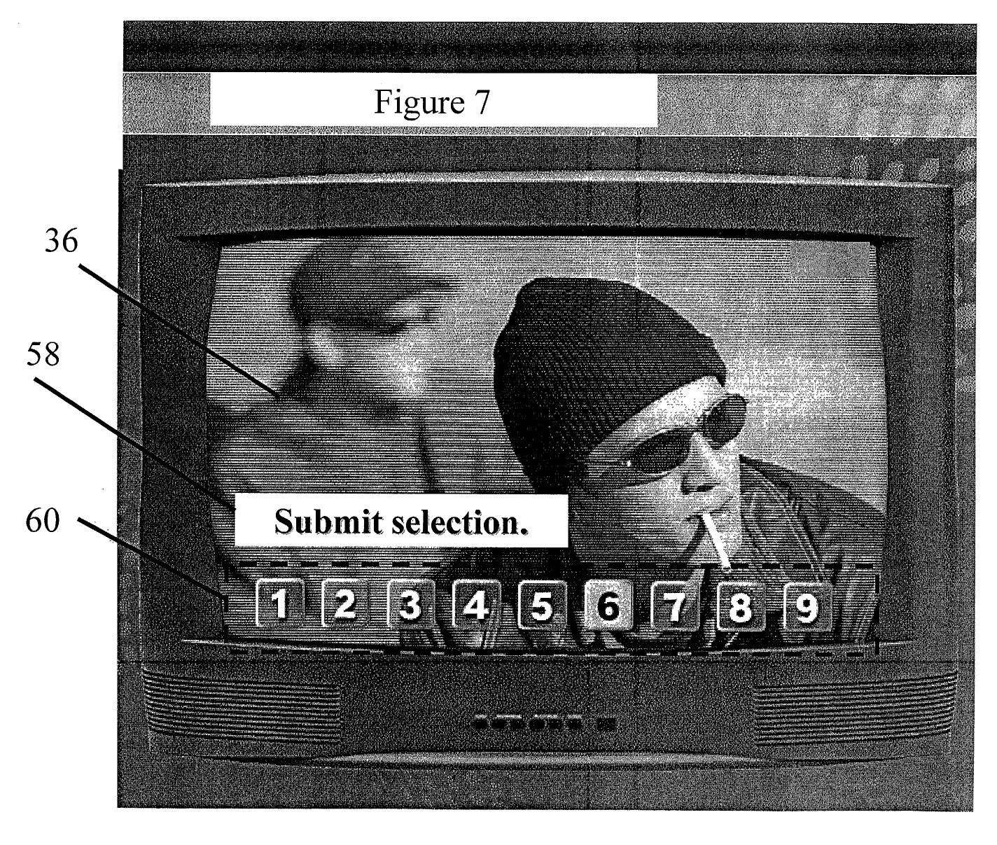

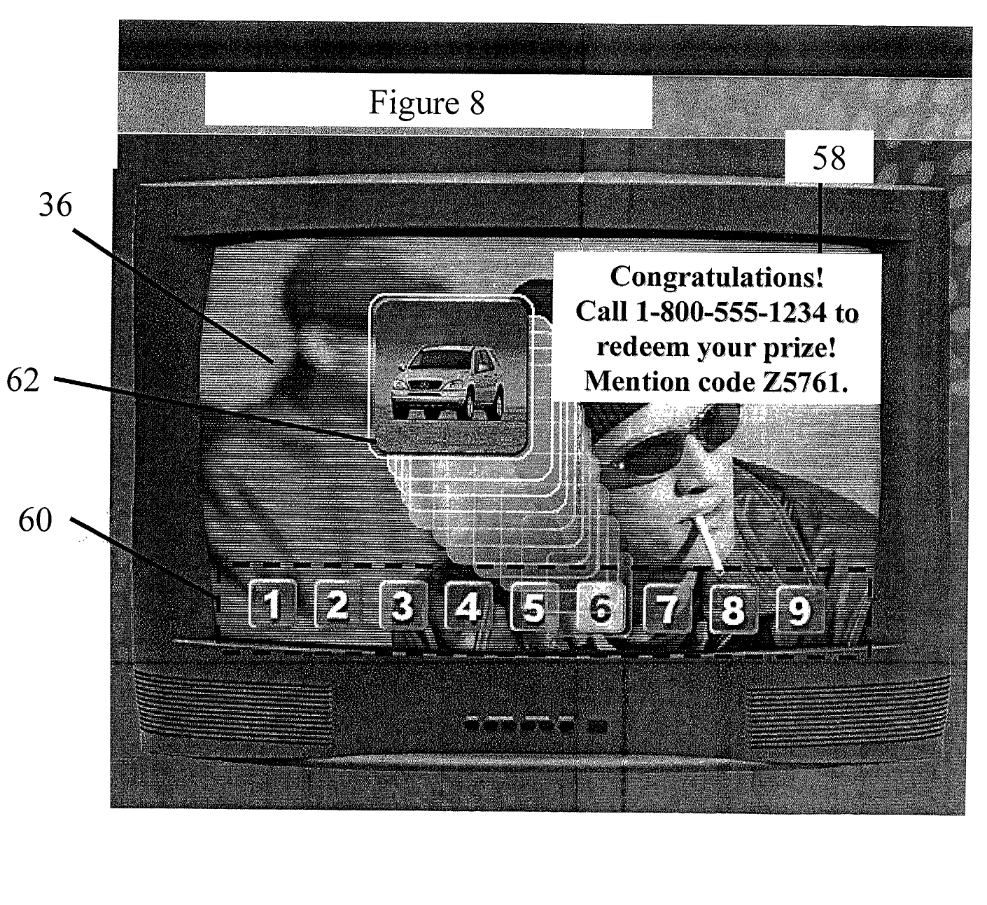

At the end of the hour (FIG. 3), the Foks are prompted 58 to ”Enter numbers” on monitor 36 in data entry fields 60 which appear superimposed on normal programming content. Lil Foks enters the digits 6 8 1 0 3 2 7 6 1 using the keypad of the television remote control. As she enters the ninth digit, she is prompted 58 to “Submit entry” (FIG. 4), which is accomplished by holding down the 100 key on the remote. The 9-digit number constitute input 88 of additional data 46 to verify actual consumption 84. If the entered numbers were incorrect, the foks would have seen FIG. 5 on monitor 36. However, in this case, all 9 digits are correct. Therefore, Lil is prompted 58 to “pick a prize” by selecting 1 of 9 data entry fields. According to some embodiments of the present invention, Lil Foks might be eligible to choose more than one data entry field, for example if the Foks had accrued a large number of points in the axis rewards program. Lil picks number 6 (FIG. 7), and is prompted 58 to submit selection. In response (FIG. 8) a prize window 62 displaying a Sport Utility Vehicle appears. The Foks are prompted 58 to “Call 1-800-555-1234 to redeem your prize! Mention code Z5761.” Code Z5761 is a single use account number which verifies that the Foks actually were awarded the vehicle.

Typically, prizes in a lottery of the type described herein will be provided by sponsors providing advertising content 24, or by the service provider (e.g. Axial Cable).

Even if the Foks had not won the lottery, the incentive to use their access card at participating merchants would be strong since it would offer them a discount. Correlation 92 of their purchase transactions to actual consumption 50 of advertising content 24 is therefore feasible using the present invention. This allows for development of micro-marketing strategies not feasible using prior art marketing and ratings systems.

In the above example, the Axis card serves as a designated rewards account, as an account with a consortium of merchants and a broadcast service provider account. The axis card also provides a means of correlating purchase behavior of Foks 22 if it is linked to a purchase account as defined hereinabove.

It will be appreciated that Axial Cable may run multiple rewards programs. These programs may operate either synergistically or in competition with one another. Similarly, much of the advertising content broadcast on the 164 Axial channels is not part of a rewards program.

If the axis rewards program is successful, it will play a part in governing decisions of audience members 22 concerning what content (23 and 24) to consume. In some cases, Axial may advertise its rewards program on channels which are not part of the rewards program.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for encouraging consumption of advertising content by individual broadcast audience members belonging to a plurality of broadcast audience members by rewarding the individual broadcast audience member that consumes advertising content, the system comprising:
(a) a first data collection mechanism, said first data collection mechanism designed and configured to ascertain a time at which, and a channel on which, content is consumed by an individual broadcast audience member belonging to the plurality of broadcast audience members;
(b) a second data collection mechanism, said second data collection mechanism designed and configured to determine a time at which, and a channel on which, the advertising content is broadcast;
(c) a comparison mechanism, said comparison mechanism designed and configured to determine actual consumption of the advertising content by said individual broadcast audience member belonging to the plurality of broadcast audience members; and (d) a reward mechanism, said reward mechanism designed and configured to credit an account of said individual broadcast audience member belonging to the plurality of broadcast audience members with a reward;
wherein said first data collection mechanism and said second data collection mechanism are each capable of communicating collected data to said comparison mechanism; and
wherein said comparison mechanism is capable of communicating data concerning said actual consumption to said reward mechanism.

2. The system of claim 1, wherein said actual consumption is deemed to occur only if said individual broadcast audience member inputs additional data to said first data collection mechanism, said additional data verifying said actual consumption.

3. The system of claim 1, wherein the advertising content is delivered in sequence with programming content.

4. The system of claim 1, wherein the advertising content is embedded within programming content.

5. The system of claim 1, wherein said broadcast occurs in a medium selected from the group consisting of television and radio.

6. The system of claim 1, wherein said broadcast is selected from the group consisting of a conventional broadcast, a cable broadcast, a satellite broadcast, a wireless broadcast and combinations thereof.

7. The system of claim 1, wherein said reward is selected from the group consisting of at least one point, at least one credit, a discount, a tangible prize, a monetary award, a chance to participate in a quiz and a chance to participate in a lottery.

8. The system of claim 1 further comprising:
(e) a reward redemption mechanism.

9. The system of claim 8, wherein said reward redemption mechanism employs at least one item selected from the group consisting of a prize redemption channel, the Internet, a telephone connection, a fax connection, a credit card, a designated membership card and a merchant.

10. The system of claim 1, wherein said account is selected from the group consisting of a designated rewards account, a credit card account, a bank account, an account with a merchant, an account with a consortium of merchants and a broadcast service provider account.

11. The system of claim 2, wherein said additional data includes answers to questions concerning the advertising content broadcast.

12. A system for encouraging consumption of advertising content by individual broadcast audience members belonging to a plurality of broadcast audience members by rewarding the individual broadcast audience members that consume advertising content, the system comprising:
(a) a broadcast infrastructure broadcasting the advertising content to the plurality of broadcast audience members;
(b) a mechanism for verifying actual consumption of the advertising content by an individual broadcast audience member belonging to the plurality of broadcast audience members; and
(c) a mechanism for rewarding said individual broadcast audience member belonging to the plurality of broadcast audience members in return for said actual consumption.

13. The system of claim 12, wherein said actual consumption is deemed to occur only if said individual broadcast audience member inputs additional data to said first data collection mechanism, said additional data verifying said actual consumption.

14. The system of claim 12, wherein the advertising content is delivered in sequence with programming content.

15. The system of claim 12, wherein the advertising content is embedded within programming content.

16. The system of claim 12, wherein said broadcast occurs in a medium selected from the group consisting of television and radio.

17. The system of claim 12, wherein said broadcast is selected from the group consisting of a conventional broadcast, a cable broadcast, a satellite broadcast, a wireless broadcast and combinations thereof.

18. The system of claim 12, wherein said reward is selected from the group consisting of at least one point, at least one credit, a discount, a tangible prize, a monetary award, a chance to participate in a quiz and a chance to participate in a lottery.

19. The system of claim 12, further comprising:
(e) a reward redemption mechanism.

20. The system of claim 19, wherein said reward redemption mechanism employs at least one item selected from the group consisting of a prize redemption channel, the Internet, a telephone connection, a fax connection, a credit card, a designated membership card and a merchant.

21. The system of claim 12, wherein said mechanism for rewarding employs an account is selected from the group consisting of a designated rewards account, a credit card account, a bank account, an account with a merchant, an account with a consortium of merchants and a broadcast service provider account.

22. The system of claim 13, wherein said additional data includes answers to questions concerning the advertising content broadcast.

23. A method for encouraging consumption of advertising content by individual broadcast audience members belonging to a plurality of broadcast audience members by rewarding the individual broadcast audience members that consume advertising content, the method comprising the steps of:
(a) broadcasting the advertising content to the plurality of broadcast audience members;
(b) verifying actual consumption of the advertising content by an individual broadcast audience member belonging to the plurality of broadcast audience members; and
(c) rewarding said individual broadcast audience member belonging to the plurality of broadcast audience members in return for said actual consumption.

24. The method of claim 23, wherein said step of verifying includes requiring input of additional data by said individual broadcast audience member, said additional data verifying said actual consumption.

25. The method of claim 23, wherein said step of broadcasting the advertising content occurs sequentially with broadcasting of programming content.

26. The method of claim 23, wherein said step of broadcasting the advertising content includes embedding the advertising content within programming content.

27. The method of claim 23, wherein said step of broadcasting occurs in a medium selected from the group consisting of television and radio.

28. The method of claim 23, wherein said step of broadcasting occurs via a means selected from the group consisting of conventional broadcasting, cable broadcasting, satellite broadcasting, wireless broadcasting and combinations thereof.

29. The method of claim 23, wherein said step of rewarding includes issuing a reward selected from the group consisting of at least one point, at least one credit, a discount, a tangible prize, a monetary award, a chance to participate in a quiz and a chance to participate in a lottery.

30. The method of claim 23, further comprising the step of
(d) facilitating redemption of a reward issued during said step of rewarding.

31. The method of claim 30, wherein said step of facilitating redemption employs at least one item selected from the group consisting of a prize redemption channel, the Internet, a telephone connection, a fax connection, a credit card, a designated membership card and a merchant.

32. The method of claim 23, wherein said step of rewarding employs an account selected from the group consisting of a designated rewards account, a credit card account, a bank account, an account with a merchant, an account with a consortium of merchants and a broadcast service provider account.

33. The method of claim 24, wherein said additional data includes answers to questions concerning the advertising content broadcast.

34. A system for measuring the effect of rewarding individual broadcast audience members belonging to a plurality of broadcast audience members for consumption of advertising content, the system comprising:
(a) a broadcast infrastructure broadcasting the advertising content to the plurality of broadcast audience members;
(b) a mechanism for verifying actual consumption of the advertising content by an individual broadcast audience members belonging to the plurality of broadcast audience members;
(c) a mechanism for rewarding said individual broadcast audience member belonging to the plurality of broadcast audience members in return for said actual consumption;
(d) a database containing information from said mechanism for rewarding correlated to information concerning purchases made by said individual broadcast audience member.

35. The system of claim 34, wherein said actual consumption is deemed to occur only if said individual broadcast audience member inputs additional data to said first data collection mechanism, said additional data verifying said actual consumption.

36. The system of claim 34, wherein the advertising content is delivered in sequence with programming content.

37. The system of claim 34, wherein the advertising content is embedded within programming content.

38. The system of claim 34, wherein said broadcast occurs in a medium selected from the group consisting of television and radio.

39. The system of claim 34, wherein said broadcast is selected from the group consisting of a conventional broadcast, a cable broadcast, a satellite broadcast, a wireless broadcast and combinations thereof.

40. The system of claim 34, wherein said reward is selected from the group consisting of at least one point, at least one credit, a discount, a tangible prize, a monetary award, a chance to participate in a quiz and a chance to participate in a lottery.

41. The system of claim 34 further comprising:
(e) a reward redemption mechanism.

42. The system of claim 41, wherein said reward redemption mechanism employs at least one item selected from the group consisting of a prize redemption channel, the Internet, a telephone connection, a fax connection, a credit card, a designated membership card and a merchant.

43. The system of claim 34, wherein said account is selected from the group consisting of a designated rewards account, a credit card account, a bank account, an account with a merchant, an account with a consortium of merchants and a broadcast service provider account.

44. The system of claim 35, wherein said additional data includes answers to questions concerning the advertising content broadcast.

45. The system of claim 34, wherein said database correlates information from said mechanism for rewarding to information concerning purchases made by said individual broadcast audience member by means of a purchasing account.

46. The system of claim 45, wherein said purchasing account is selected from the group consisting of a credit card account, a debit card account, a consumer club account and, a merchant based account and combinations thereof.

47. A method for measuring the effect of rewarding individual broadcast audience members belonging to a plurality of broadcast audience members for consumption of advertising content, the method comprising the steps of:
(a) broadcasting advertising content to the plurality of broadcast audience members;
(b) verifying actual consumption of said advertising content by an individual broadcast audience member belonging to the plurality of broadcast audience members; and
(d) rewarding said individual broadcast audience member belonging to the plurality of broadcast audience members in return for said actual consumption; and
(e) correlating information concerning said step of rewarding to information concerning purchases made by said individual broadcast audience member.

48. The method of claim 47, wherein said step of verifying includes requiring input of additional data by said individual broadcast audience member, said additional data verifying said actual consumption.

49. The method of claim 47, wherein said step of broadcasting the advertising content occurs sequentially with broadcasting of programming content.

50. The method of claim 47, wherein said step of broadcasting the advertising content includes embedding the advertising content within programming content.

51. The method of claim 47, wherein said step of broadcasting occurs in a medium selected from the group consisting of television and radio.

52. The method of claim 47, wherein said step of broadcasting occurs via a means selected from the group consisting of conventional broadcasting, cable broadcasting, satellite broadcasting, wireless broadcasting and combinations thereof.

53. The method of claim 47, wherein said step of rewarding includes issuing a reward selected from the group consisting of at least one point, at least one credit, a discount, a tangible prize, a monetary award, a chance to participate in a quiz and a chance to participate in a lottery.

54. The method of claim 47, further comprising the step of:
(e) facilitating redemption of a reward issued during said step of rewarding.

55. The method of claim 54, wherein said step of facilitating redemption employs at least one item selected from the group consisting of a prize redemption channel, the Internet, a telephone connection, a fax connection, a credit card, a designated membership card and a merchant.

56. The method of claim 47, wherein said step of rewarding employs an account selected from the group consisting of a designated rewards account, a credit card account, a bank account, an account with a merchant, an account with a consortium of merchants and a broadcast service provider account.

57. The method of claim 48, wherein said additional data includes answers to questions concerning the advertising content broadcast.

58. The method of claim 47, wherein said database correlates information from said mechanism for rewarding to information concerning purchases made by said individual broadcast audience member by means of a purchasing account.

59. The method of claim 58, wherein said purchasing account is selected from the group consisting of a credit card account, a debit card account, a consumer club account and, a merchant based account and combinations thereof.
